(19) United States
(12) Patent Application Publication
(10) Pub. No.: US 2022/0164698 A1
(43) Pub. Date: May 26, 2022

(54) AUTOMATED DATA QUALITY INSPECTION AND IMPROVEMENT FOR AUTOMATED MACHINE LEARNING

(71) Applicant: International Business Machines Corporation, Armonk, NY (US)

(72) Inventors: Arunima Chaudhary, Boston, MA (US); Dakuo Wang, Cambridge, MA (US); Abel Valente, Villa Elisa (AR); Carolina Maria Spina, Olavarria (AR); Hima Patel, Bengaluru (IN); Nitin Gupta, Saharanpur (IN); Gregory Bramble, Larchmont, NY (US); Horst Cornelius Samulowitz, Armonk, NY (US); Sameep Mehta, Bangalore (IN); Theodoros Salonidis, Wayne, PA (US); Daniel M. Gruen, Newton, MA (US); Chaung Gan, Cambridge, MA (US)

(21) Appl. No.: 17/104,642

(22) Filed: Nov. 25, 2020

(51) Int. Cl. G06N 20/00; G06N 5/04

(52) U.S. Cl. CPC G06N 20/00; G06N 5/04

(57) ABSTRACT

A method to automatically assess data quality of data input into a machine learning model and remediate the data includes receiving input data for an automated machine learning model. Selections for a multiple data quality metrics are displayed. A selection for data quality metrics is received. The data quality metrics are determined according to the selection. Selections for data remediation strategies based on the selection of the data quality metrics are displayed. A selection for remediation recommendation strategies is received. The selected data remediation strategies are performed on the input data. Learning from the selection of the data quality metrics and the selection for the remediation strategies is performed. A new customized machine learning model is generated based on the learning.

### BACKGROUND

The field of embodiments of the present invention relates to automatically assessing data quality of data input into a machine learning model and data remediation.

Automatic artificial intelligence/automatic machine learning (AutoAI/AutoML) is the use of programs and algorithms to automate the end-to-end human intensive and otherwise highly skilled tasks involved in building and operationalizing AI models. As data science (DS) and ML are moving into the era of AI designing AI and AI creating AI. It is well understood that the performance of an ML model is upper bounded by the quality of the data. While researchers and practitioners have focused on improving the quality of models (such as neural architecture search and automated feature selection), there are limited efforts towards improving the data quality.

### SUMMARY

Embodiments relate to automatically assessing data quality of data input into a ML model and data remediation. One embodiment provides a method to automatically assess data quality of data input into a machine learning model and remediate the data includes receiving input data for an automated machine learning model. Selections for a multiple data quality metrics are displayed. A selection for data quality metrics is received. The data quality metrics are determined according to the selection. Selections for data remediation strategies based on the selection of the data quality metrics are displayed. A selection for remediation recommendation strategies is received. The selected data remediation strategies is performed on the input data. Learning from the selection of the data quality metrics and the selection for the remediation strategies is performed. A new customized machine learning model is generated based on the learning. The embodiments significantly improve data remediation for AutoAi/AutoML model generation. For AutoAI/AutoML systems, the features contribute to the advantage of providing an engineering process that can automatically assess the quality of the data across intelligently designed metrics (e.g., label noise, data correlation, data outliers, etc.). Some features further contribute to the advantage of developing corresponding transformation operations to address the quality gaps for training data. One or more features additionally contribute to the advantage of providing an interaction point that users can select a series of data quality metrics and corresponding parameters. Other features contribute to the advantage of providing a user interface that provides the ability to incorporate human knowledge to guide the automated feature engineering algorithm and to learn from user's preferences and domain specific information to improve system generated recommendations.

One or more of the following features may be included. In some embodiments, the selections for the data quality metrics comprise label noise, data homogeneity, data outlier detection, feature correlation and class parity.

In some embodiments, the selections for the data remediation strategies comprise remediations to the input data or a system directed configuration for learning models.

In one or more embodiments, the method may further include that the remediation strategies involving remediations to the input data comprise one or more data modification suggestions.

In some embodiments, the method may additionally include that the remediation strategies involving the system directed configuration for learning models comprise one or more directives for AutoAI model generation for generating the new customized machine learning model.

In one or more embodiments, the method may include that selections for the data quality metrics and the selections for the data remediation strategies are displayed with a graphical user interface.

In some embodiments, the method may further include modifying the input data by a table embedding model that generates remediation recommendations in tabular format for the input data.

These and other features, aspects and advantages of the present embodiments will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is a network architecture of a system for automatically assessing data quality of data input into a machine learning (ML) model and data remediation, according to an embodiment;

FIG. 4 shows a representative hardware environment that may be associated with the servers and/or clients of FIG. 1, according to an embodiment;

FIG. 5 is a block diagram illustrating a distributed system for automatically assessing data quality of data input into a ML model and data remediation, according to one embodiment;

FIG. 6 shows ten (10) stages of a data science (DS) and ML lifecycle;

FIG. 7 shows a high-level system flow diagram for automatically assessing data quality of data input into an ML model and data remediation, according to one embodiment;

FIG. 8 shows a flow diagram for an example for applying automatic assessment of data quality of data input into an ML model and data remediation, according to one embodiment;

FIG. 9 another flow diagram example for applying automatic assessment of data quality of data input into an ML model and data remediation, according to one embodiment;

FIG. 10A shows an example user interface used for automatic assessment of data quality of data input into an ML model and data remediation, according to one embodiment;

FIG. 10B shows the example user interface of FIG. 10A showing a data quality metrics interface used for automatic assessment of data quality of data input into an ML model and data remediation, according to one embodiment;

FIG. 10C shows the example user interface of FIG. 10A showing a data source inspector/preview interface used for automatic assessment of data quality of data input into an ML model and data remediation, according to one embodiment;

FIG. 11 shows a table of data quality metrics and remediation strategies, according to one embodiment; and

FIG. 12 illustrates a block diagram of a process for automatic assessment of data quality of data input into an ML model and data remediation, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to automatically assessing data quality of data input into a ML model and data remediation. One embodiment provides a method of using a computing device to automatically assess data quality of data input into a machine learning model and remediate the data. The method includes receiving, by a computing device, input data for an automated machine learning model. The computing device displays selections for a plurality of data quality metrics. The computing device further receives a selection for one or more data quality metrics from the plurality of data quality metrics. The computing device additionally determines the one or more data quality metrics according to the selection of the one or more data quality metrics. The computing device further displays selections for one or more data remediation strategies based on the selection of the one or more data quality metrics. The computing device still further receives a selection for one or more remediation recommendation strategies. The computing device additionally performs the selected one or more data remediation strategies on the input data. The computing device further learns from the selection of the one or more data quality metrics and the selection for the one or more data remediation strategies. The computing device still further generates a new customized machine learning model based on the learning.

AI models may include a trained ML model (e.g., models, such as a NN, a convolutional NN (CNN), a recurrent NN (RNN), a Long short-term memory (LSTM) based NN, gate recurrent unit (GRU) based RNN, tree-based CNN, self-attention network (e.g., an NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

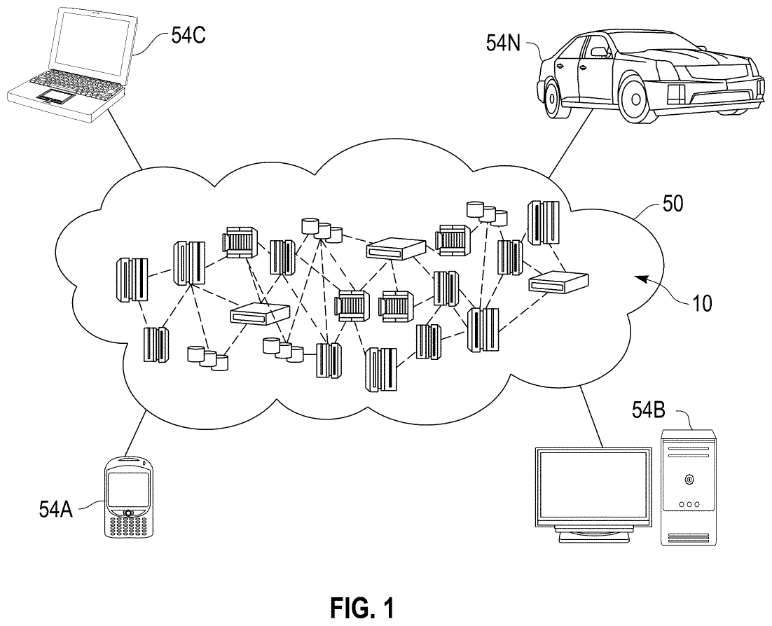

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

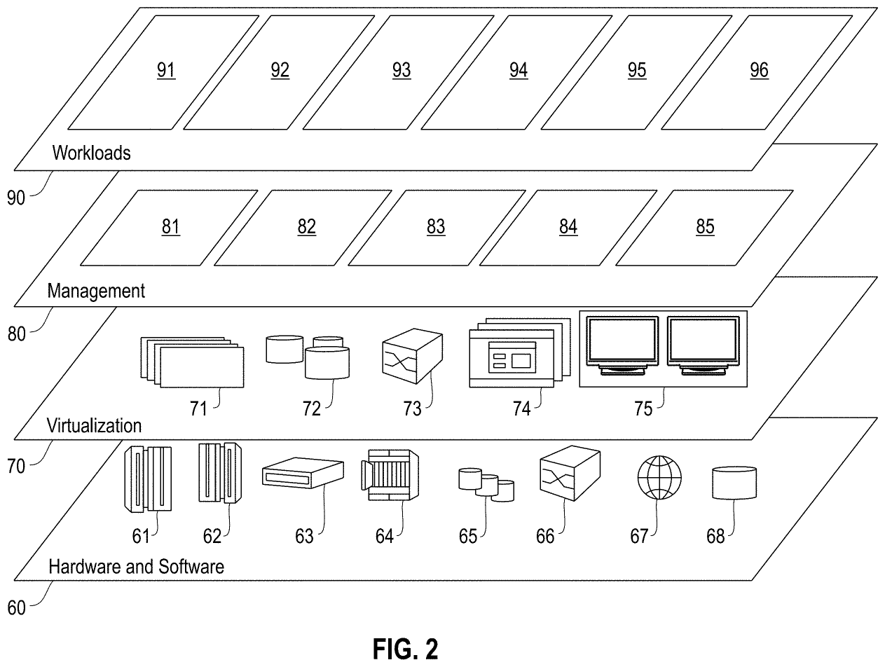

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

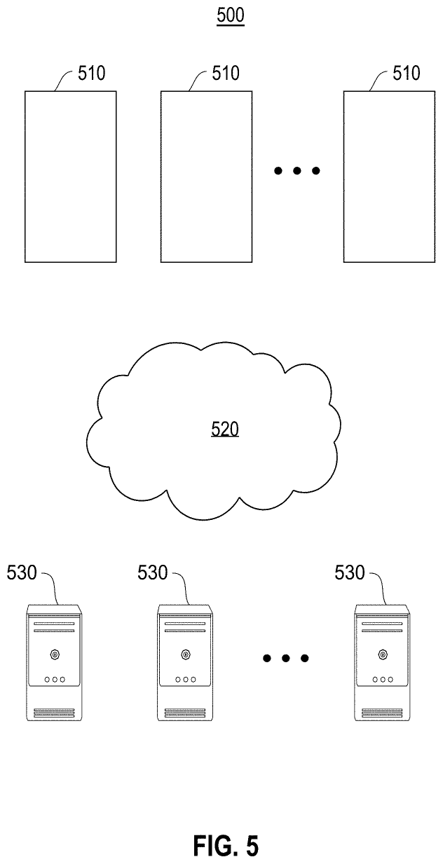

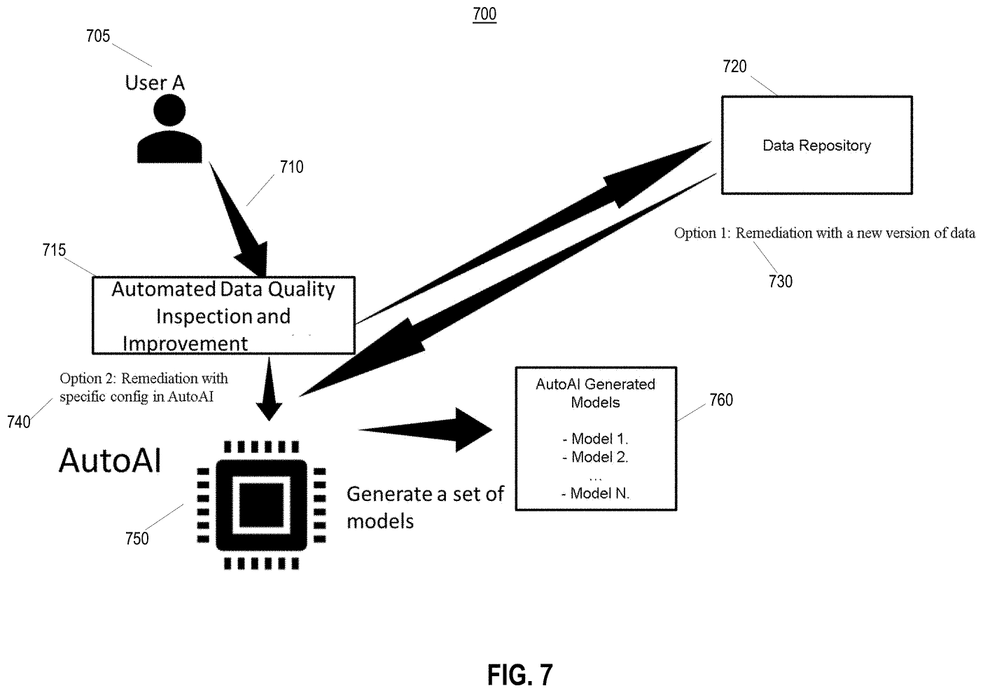

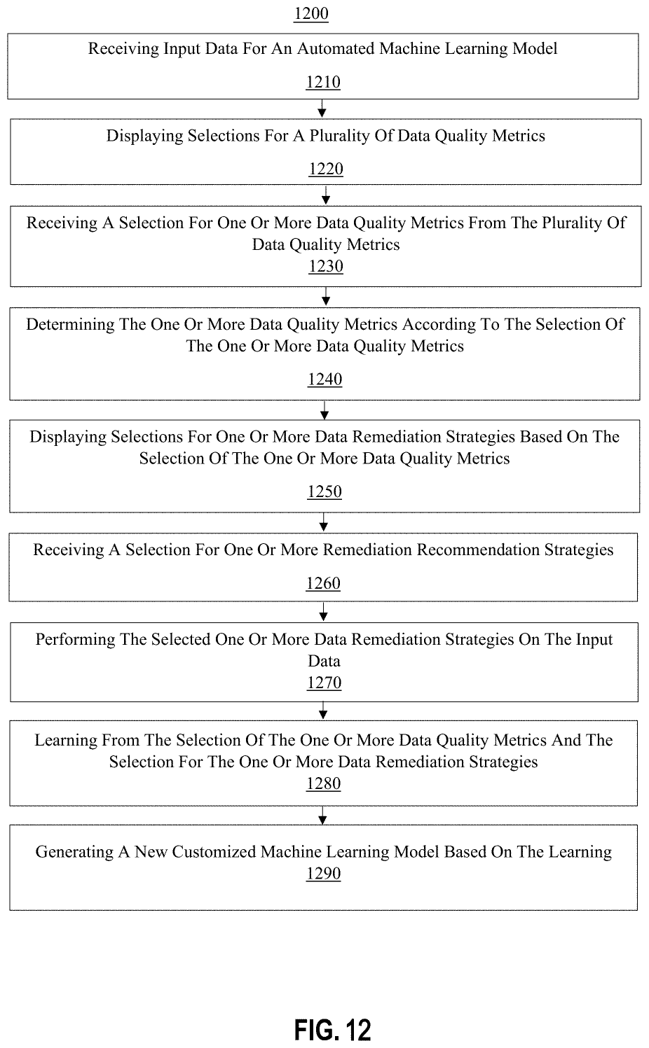

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for automatic assessment of data quality of data input into an ML model and data remediation processing 96 (see, e.g., system 500, FIG. 5, system 700, FIG. 7 and process 1200, FIG. 12). As mentioned above, all of the foregoing examples described with respect to FIG. 2 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

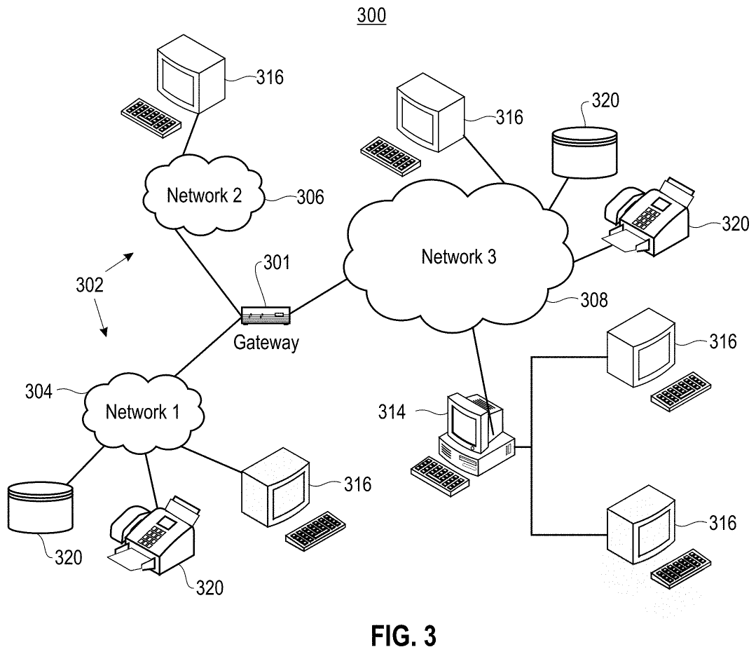

FIG. 3 is a network architecture of a system 300 for automatic assessment of data quality of data input into an ML model and data remediation processing, according to an embodiment. As shown in FIG. 3, a plurality of remote networks 302 are provided, including a first remote network 304 and a second remote network 306. A gateway 301 may be coupled between the remote networks 302 and a proximate network 308. In the context of the present network architecture 300, the networks 304, 306 may each take any form including, but not limited to, a LAN, a WAN, such as the Internet, public switched telephone network (PSTN), internal telephone network, etc.

In use, the gateway 301 serves as an entrance point from the remote networks 302 to the proximate network 308. As such, the gateway 301 may function as a router, which is capable of directing a given packet of data that arrives at the gateway 301, and a switch, which furnishes the actual path in and out of the gateway 301 for a given packet.

Further included is at least one data server 314 coupled to the proximate network 308, which is accessible from the remote networks 302 via the gateway 301. It should be noted that the data server(s) 314 may include any type of computing device/groupware. Coupled to each data server 314 is a plurality of user devices 316. Such user devices 316 may include a desktop computer, laptop computer, handheld computer, printer, and/or any other type of logic-containing device. It should be noted that a user device 316 may also be directly coupled to any of the networks in some embodiments.

A peripheral 320 or series of peripherals 320, e.g., facsimile machines, printers, scanners, hard disk drives, networked and/or local storage units or systems, etc., may be coupled to one or more of the networks 304, 306, 308. It should be noted that databases and/or additional components may be utilized with, or integrated into, any type of network element coupled to the networks 304, 306, 308. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICROSOFT® WINDOWS® system that emulates an IBM® z/OS environment, etc. This virtualization and/or emulation may be implemented through the use of VMWARE® software in some embodiments.

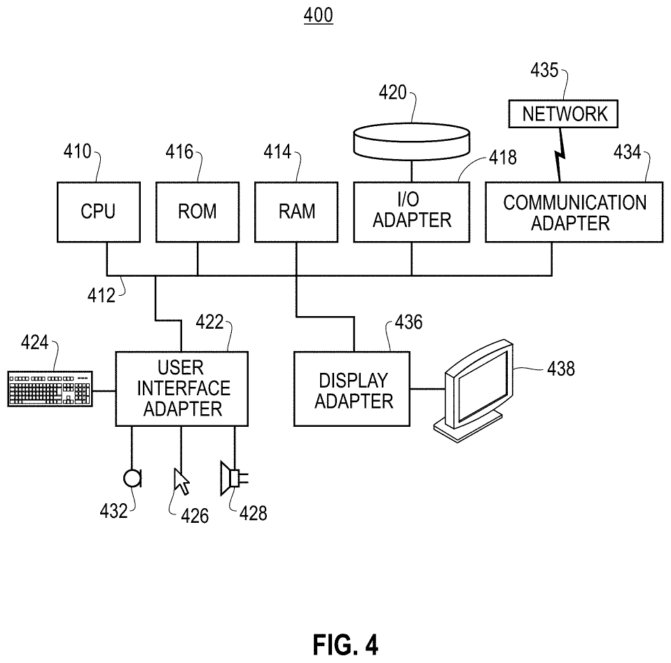

FIG. 4 shows a representative hardware system 400 environment associated with a user device 316 and/or server 314 of FIG. 3, in accordance with one embodiment. In one example, a hardware configuration includes a workstation having a central processing unit 410, such as a microprocessor, and a number of other units interconnected via a system bus 412. The workstation shown in FIG. 4 may include a Random Access Memory (RAM) 414, Read Only Memory (ROM) 416, an I/O adapter 418 for connecting peripheral devices, such as disk storage units 420 to the bus 412, a user interface adapter 422 for connecting a keyboard 424, a mouse 426, a speaker 428, a microphone 432, and/or other user interface devices, such as a touch screen, a digital camera (not shown), etc., to the bus 412, communication adapter 434 for connecting the workstation to a communication network 435 (e.g., a data processing network) and a display adapter 436 for connecting the bus 412 to a display device 438.

In one example, the workstation may have resident thereon an operating system, such as the MICROSOFT® WINDOWS® Operating System (OS), a MAC OS®, a UNIX® OS, etc. In one embodiment, the system 400 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 5 is a block diagram illustrating a distributed system 500 for automatic assessment of data quality of data input into an ML model and data remediation, according to one embodiment. In one embodiment, the system 500 includes client devices 510 (e.g., mobile devices, smart devices, computing systems, etc.), a cloud or resource sharing environment 520 (e.g., a public cloud computing environment, a private cloud computing environment, a data center, etc.), and servers 530. In one embodiment, the client devices 510 are provided with cloud services from the servers 530 through the cloud or resource sharing environment 520.

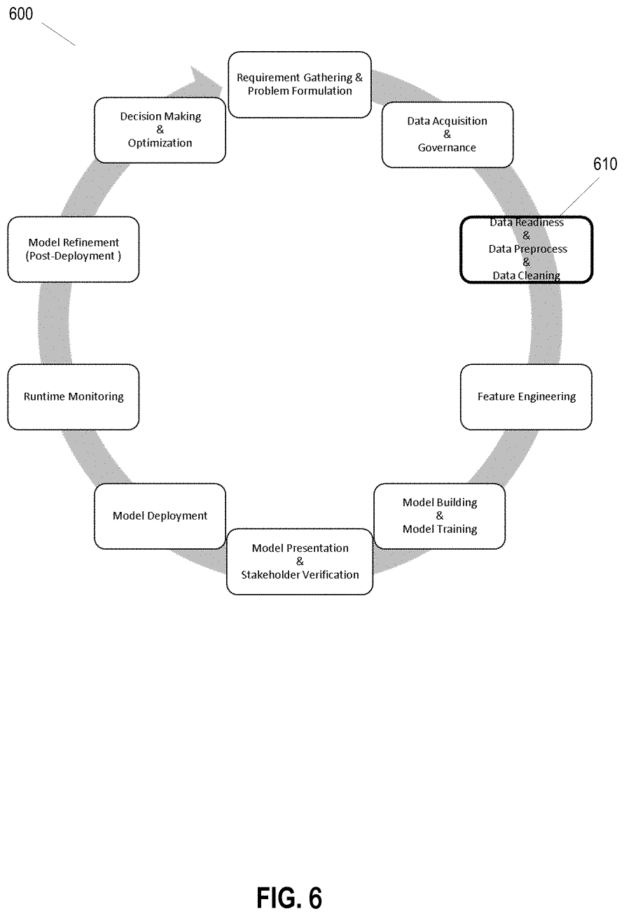

FIG. 6 shows ten (10) stages of a DS/ML lifecycle 600. DS and ML are the backbone of today's data-driven business decision making. The term “DS/ML lifecycle” is used to collectively refer to the entire flow of a DS project. Within the DS/ML lifecyle 600, the term “stage” is used to describe the conceptual separation of tasks, and the term “sub-tasks” is used to describe the detailed action or task that DS/ML practitioners performed in it. From a human centered perspective, ML often consists of multiple stages: from gathering requirements and datasets, to deploying a model, and to supporting human decision making; these stages together are referred to as the DS/ML lifecycle 600. There are also diverse personas in a DS/ML team and these personas must coordinate across the DS/ML lifecycle 600: stakeholders set requirements, data scientists define a plan, and data engineers and ML engineers support with data cleaning and model building. Later, stakeholders verify the model and domain experts use model inferences in decision making, and so on. Throughout the DS/ML lifecycle 600, refinements may be performed at various stages, as needed. It is such a complex and time-consuming activity that there are not enough DS/ML professionals to fill the job demands; and as much as 80% of their time is spent on low-level activities such as adjusting data or trying out various algorithmic options and model tuning. These two challenges: dearth of data scientists, and time-consuming low-level activities, have stimulated AI researchers and system builders to explore an automated solution for DS/ML work: Automated Data Science (AutoML).

Several AutoML algorithms and systems have been built to automate several stages of the DS/ML lifecycle 600. For example, the ETL (extract/transform/load) task has been applied to the data readiness, preprocessing and cleaning stage 610. Another heavily investigated stage is feature engineering, for which many new techniques have been developed such as deep feature synthesis, one button machine, reinforcement learning-based exploration, and historical pattern learning. Such work, however, often targets only a single stage of the DS/ML lifecycle 600. For example, one method can automate the model building and training stage by automatically searching for the optimal algorithm and hyperparameter settings, but it offers no support for examining the training data quality, which is a critical step before the training starts.

In recent years, a growing number of companies and research organizations have started to invest in driving automation across the full end-to-end AutoML system. Most of these systems aim to support end-to-end DS/ML automation. Current capabilities, however, are focused on the model building and data analysis stages, while little automation is offered for the human-labor-intensive and time-consuming data preparation or model runtime monitoring stages.

The DS/ML lifecycle 600 is an iterative and staged process. The DS/ML lifecycle 600 often starts with the stage of requirement gathering and problem formulation, followed by data cleaning and engineering, model training and selection, model tuning and ensembles, and finally deployment and monitoring. AutoML is the endeavor of automating each stage of this process separately or jointly. The data cleaning portion of the data readiness, data preprocess and data cleaning stage 610 focuses on improving data quality. Data cleaning involves an array of tasks such as missing value imputation, duplicate removal, noise correction, invalid values and other data collection errors. A data fusion stage deals with combining various data sources. The feature engineering stage is a complicated and time consuming task, which involves altering the feature space to improve modeling accuracy. Automation has been achieved through approaches like reinforcement learning, trial and error methodology, historical pattern learning and more recently through knowledge graphs. The hyperparameter selection stage is used to fine tune a model or the sequence of steps in a model pipeline.

AutoML has witnessed considerable progress in recent years, in research as well as application in commercial products. Various AutoML research efforts have moved beyond the automation on one specific step. Joint optimization, a type of Bayesian-optimization-based algorithms, enables AutoML to automate multiple tasks together. For example, some conventional methods automate the model selection, hyperparameter optimization, and ensembling steps of the DS/ML lifecycle 600 pipeline. The result coming out of such AutoML system is called a “model pipeline.” A model pipeline is not only about the model algorithm; it emphasizes the various data manipulation actions (e.g., filling in a missing value(s)) before the model algorithm is selected, and the multiple model improvement actions (e.g., optimize the best values for model's hyperparameters) after the model algorithm is selected.

Model ensembles have become a mainstay in ML. Many AutoML systems generate a final output model pipeline as an ensemble of multiple model algorithms instead of a single algorithm. More specifically, the ensemble algorithm includes: 1) ensemble selection, which is a greedy-search-based algorithm that starts with an empty set of models, incrementally adds a model to the working set, and selects that model if such addition results in improving the predictive performance of the ensemble; 2) and, genetic programming algorithm, which does not create an ensemble of multiple model algorithms, but it can compose derived model algorithms. An advanced version of the genetic programming algorithm uses multi-objective genetic programming to evolve a set of accurate and diverse models via introducing bias into the fitness function accordingly.

With the recent advancement of AutoML research, more and more researchers have started to explore the possibility of a full end-to-end AutoML system. In that vision, from the requirement gathering and problem formulation, to data cleaning, to model building and deployment, and eventually to decision making, no human is needed in this process. Some companies have also expressed their interest in AutoML systems that can fully autopilot the end-to-end DS/ML lifecycle 600. A fully automated end-to-end DS/ML lifecycle, however, may not be what DS/ML practitioners want in practice. Even for traditional AI/ML practices, users reported difficulties in understanding AI/ML systems functionality, and find it difficult to trust an ML model or an AI system that they do not understand. Hence, a group of AI and human-computer interaction (HCI) researchers started working on the human-in-the-loop (HITL) AI/ML research thread in recent years. One example proposed design guidelines for developing human-guided ML systems based on their own experience and on surveying the research literature; and another proposed AI design guidelines that emphasized the human labelers' and coders' interactions with the system.

An end-to-end automated DS/ML lifecycle may benefit from human DS/ML practitioners in the loop. The HITL AI/ML systems provided inspirational but limited knowledge for understanding this new research topic, because: (1) the target user population is different, the HITL-AI design guidelines emphasize the design of applications for end users, such as doctors and customers, to help them understand the AI recommendation and to make a better decision. The HITL-ML designs focus on building interactive user interfaces either to support data labelers to efficiently label data, or to support ML engineers to check model performance via a visualization. However, in the end-to-end AutoML research, the target users include both traditional ML engineers and data labelers, but also other DS workers such as sales people, citizen data scientists, or business stakeholders. These targeted users have very different expectations and requirements, and sometimes their interests may conflict with each other.

In the traditional ML context, people provide one input data point, and it generates one prediction outcome. Thus people can use this relational projection to rationalize how the model works. But, in an AutoML workflow, the ML model is simply a component of the AutoML's output pipeline. Interpreting and controlling one ML model is hard, to interpret and to control an AutoML process that simultaneously can generate hundreds of ML models is harder. The autopilot level of intelligence may dramatically change how these DS/ML practitioners do their job, and may even threaten their job security in the long term. On the other hand, an autopilot AutoML may help today's non-technical DS/ML practitioners, such as stakeholders, by reducing the boundary for them to build a model on their own. But, foremost the fundamental research question that needs answering is: Do DS and ML workers really want AutoML to automate the end-to-end lifecycle?

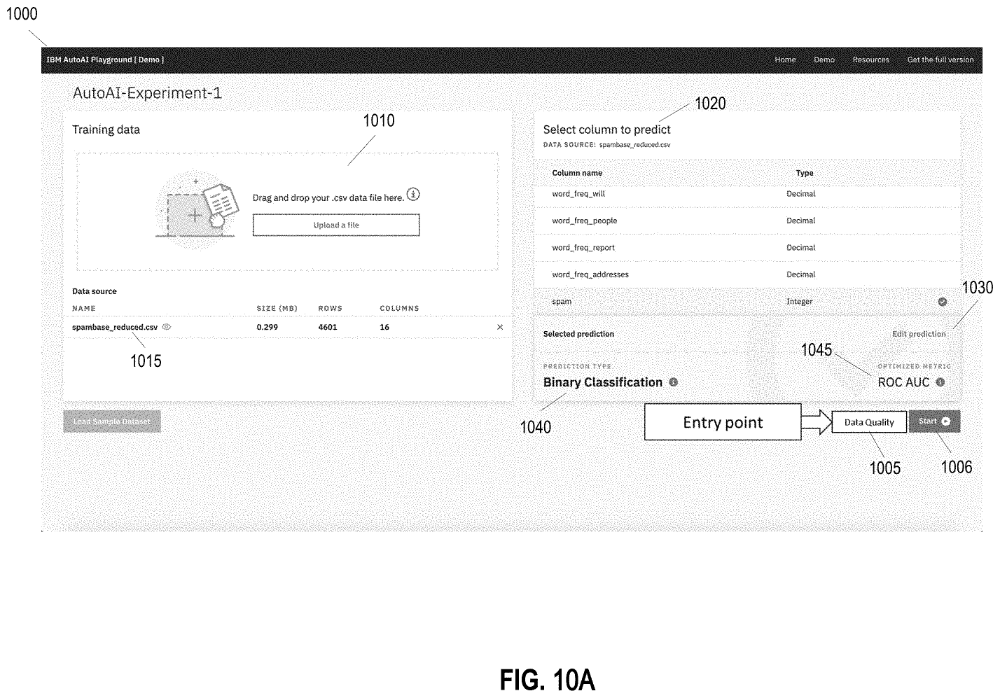

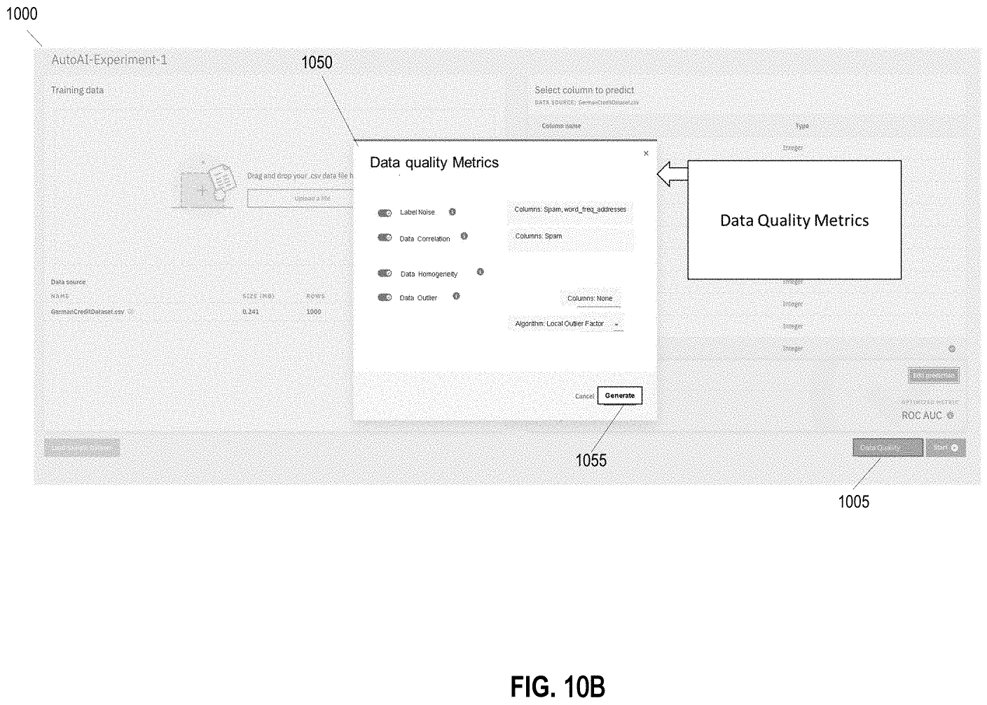

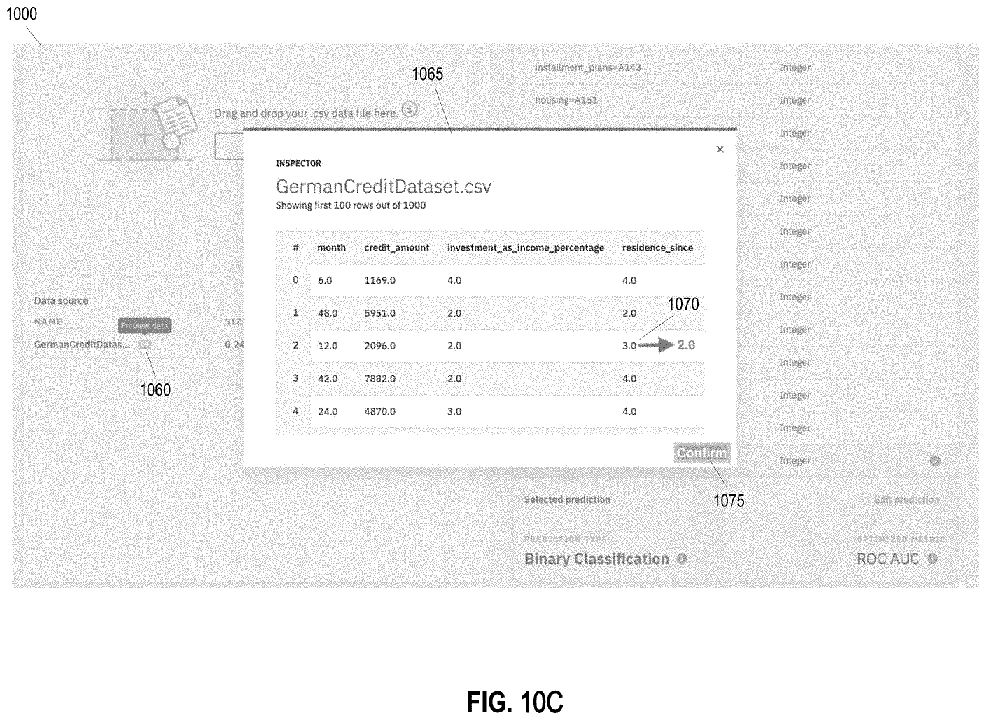

Some embodiments improve data remediation for AutoAI/AutoML systems by providing a learning-based approach to leverage on ML models to detect data quality and automatically discover ways to enhance data quality with a system design that allows a user to interactively select the recommended ways of improving the AutoAI results. In the DS/ML lifecycle 600, for the data readiness, data preprocess and data cleaning stage 610 automation are the focus of some embodiments (e.g., automated assessment of data quality, detection of data noise, and cleaning of the data). One or more embodiments provide an engineering process that can automatically assess the quality of the data across intelligently designed metrics (label noise, data correlation, data outliers, etc.). Some embodiments develop corresponding transformation operations to address the quality gaps. One embodiment provides an interaction point that users can select a series of data quality metrics and corresponding parameters. One embodiment provides an interface (e.g., interface 1000, FIGS. 10A-C) that provides the ability of users to incorporate human knowledge to guide the automated feature engineering algorithm. The system is assisted to learn from user's preferences and domain specific information to improve system generated recommendations.

FIG. 7 shows a high-level system 700 flow diagram for automatically assessing data quality of data input into an ML model and data remediation, according to one embodiment. Some embodiments address data quality in AutoAI/AutoML systems by providing a system 700 that includes an automated data quality inspection (readiness) and improvement (preprocess and cleaning) processing 715 with user monitoring and control in AutoML. The automated data quality inspection and improvement processing 715 provides a learning-based approach to leverage on ML models to detect data quality and automatically discover ways to enhance data quality with a system 700 design that allows a user (e.g., user A 705) to interactively select the recommended ways of improving the AutoAI results.

In one embodiment, the user A 705 uses an interface (e.g., user interface 1000, FIGS. 10A-C) to provide input 710 of a single data set and configuration file (e.g., for a LocalOutlierFactor ML algorithm, with a target of salary, etc.), which is input to the automated data quality inspection and improvement processing 715. The automated data quality inspection and improvement processing 715 provides processing for storing different versions of the dataset in the data repository 720 to test the efficacy of AutoAI model generation processing 750. In one embodiment, a first option (option 1 730) provides processing for data remediation with a new version of the data (e.g., amending/correcting portion(s) of the data, etc.). In another embodiment, a second option (option 2 740) provides processing for remediation with specific configuration in AutoAI model generation processing 750 (e.g., based on the data, selecting and using specific types of AI models (e.g., using AI models that are suitable for certain type of data (e.g., imbalanced data), etc.). In one embodiment, the data from the data repository is input to the AutoAI model generation processing 750 using the first or second option (or a combination thereof), and generates a set of AutoAI generated models 760.

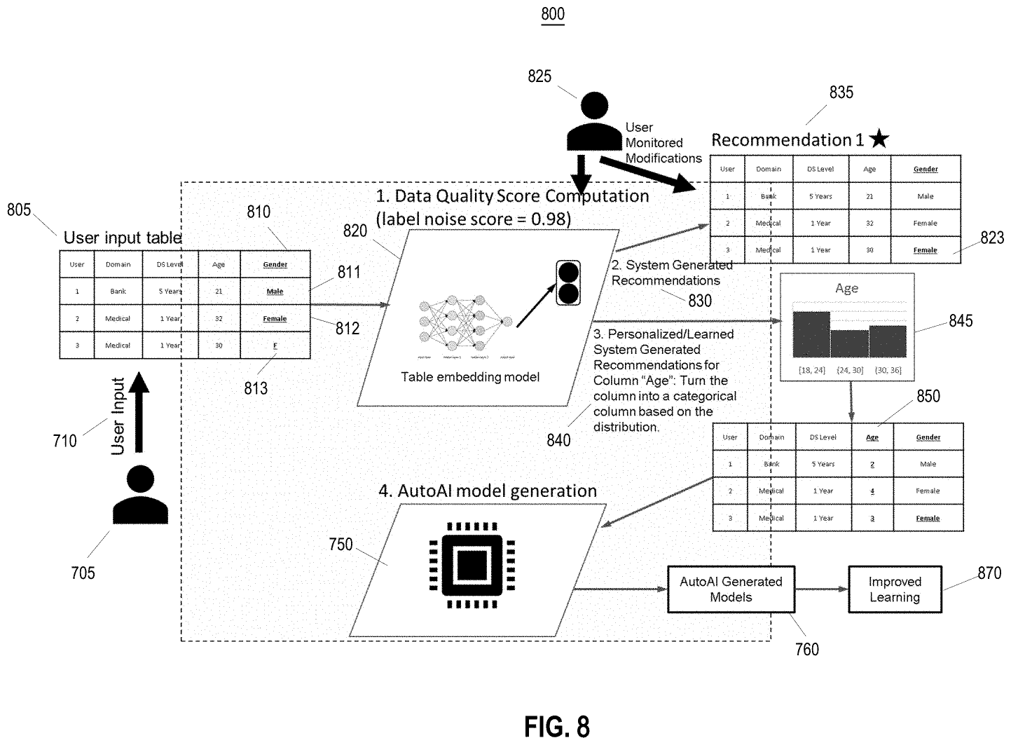

FIG. 8 shows a flow diagram 800 for an example for applying automatic assessment of data quality of data input into an ML model and data remediation, according to one embodiment. In one embodiment, the user A 705 provides input 710 that is in a user input table 805 or is placed into tabular format using a program for the user to input table 805. In this embodiment, the user A 705 is using the first option (e.g., option 1 730, FIG. 7: for remediation with a new version of data). In the example, the data for the column that includes information for gender 810 includes the data of Male 811, Female 812 and F for 813, which is different from the other two entries in the column for gender 810. In one embodiment, the user input table 805 is received or entered into a table embedding model 820 (e.g., a table embedding model that uses ML, such as a DNN table embedding model, etc.).

In one embodiment, the user A 705 (or another user) provides user monitored modifications 825 (e.g., for a data quality score computation, the label noise score is equal to 0.98) through a user interface 1000 (FIGS. 10A-C). The table embedding model 820 provides recommendations 830 that modify the data in the user input table 805. In this example embodiment, the recommendations 830 includes a generated recommendation table 835 where the original data F 813 is modified to Female 823 for consistency with data of Male 811 and Female 812 in the user input table 805. In this example embodiment, the table embedding model 820 also provides another recommendation 840 that includes personalized/learned system generated recommendations the column 850 for Age, where the numerical data in the user input table 805 is modified into a categorical column of data based on distribution 845. The final recommendation table including the modified data is input to the AutoAI model generation processing 750 that generates the AutoAI generated models 760 resulting in improved learning 870 for future users that makes use of the prior training and AutoAI generated models 760.

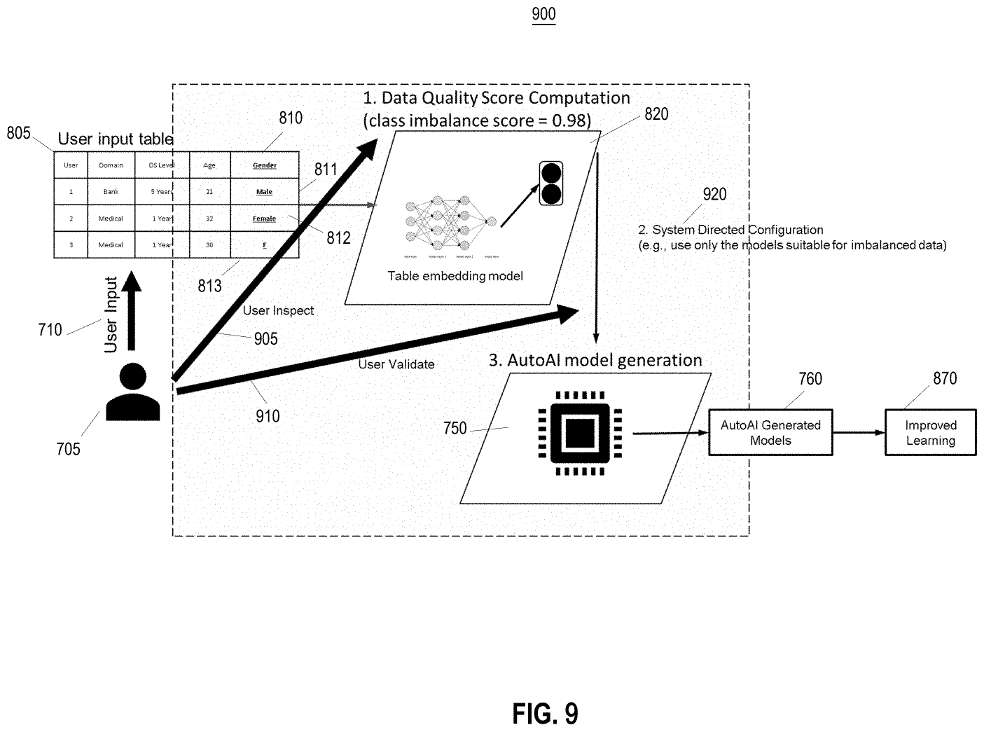

FIG. 9 shows a flow diagram 900 for another example for applying automatic assessment of data quality of data input into an ML model and data remediation, according to one embodiment. In one embodiment, the user A 705 provides input 710 that is in a user input table 805 or is placed into tabular format using a program for the user to input table 805. In this embodiment, the user A 705 is using the second option (e.g., option 2 740, FIG. 7: for remediation with a specific configuration in the AutoAI model generation processing 750). In this example, the data for the column that includes information for gender 810 includes the data of Male 811, Female 812 and F for 813, which is different from the other two entries in the column for gender 810. In one embodiment, the user input table 805 is received or entered into a table embedding model 820.

In one embodiment, the user A 705 provides inspection 905 (e.g., for a data quality score computation, the label noise score is equal to 0.98) through a user interface 1000 (FIGS. 10A-C). The table embedding model 820 provides recommendations 920 to the AutoAI model generation processing 750 to only use AI models suitable for imbalanced data, etc. In this example embodiment, the user A 705 provides user validation 910 for the configuration to use for the AutoAI model generation processing 750 (i.e., the user A 705 validates the selected configuration recommendation (e.g., only use AI models suitable for imbalanced data, etc.). Once the user A 705 validates the system directed configuration 920, the AutoAI model generation processing 750 generates the AutoAI generated models 760 resulting in improved learning 870 for future users that makes use of the prior training and AutoAI generated models 760.

FIG. 10A shows an example user interface 1000 used for automatic assessment of data quality of data input into an ML model and data remediation, according to one embodiment. In one embodiment, the user interface (or graphical user interface (GUI)) 1000 provides a user with a training data interface 1010 for uploading a training data file or dragging and dropping a training data file and showing the training data file details 1015 (e.g., in this example: spambase_reduced.csv file, size in MB, number of rows and number of columns, etc.). The user interface 1000 provides a user with a selection interface 1020 for selecting columns to predict for the data source (e.g., spambase_reduced.csv), which shows column names and type of data. The user interface 1000 further provides a user with a selected prediction interface 1030 for editing prediction. The selected prediction interface 1030 further includes the prediction type 1040 (e.g., Binary Classification, etc.) and the optimized metric 1045 (e.g., ROC AUC (receiver operating characteristic (ROC) curve and area under curve (AUC), AUC ROC, etc.). In one embodiment, the entry point for automatic assessment of data quality of data input into an ML model and data remediation is the data quality button or selection 1005 for starting the entering process for data quality metrics through a data quality metrics interface 1050 (FIG. 10B). The start button or selection 1006 starts the AutoAI model generation processing 750 (FIGS. 7-9).

FIG. 10B shows the example user interface 1000 of FIG. 10A showing a data quality metrics interface 1050 used for automatic assessment of data quality of data input into an ML model and data remediation, according to one embodiment. In one embodiment, the data quality metrics interface 1050 provides various selections, such as label noise, data correlation, data homogeneity, data outlier, and views for columns span, word_freq_addresses, column span, columns none, algorithm selection (e.g., a drop-down menu, etc.), for example: local outlier factor, etc. Once the user has provided the desired data quality metrics, the generate button or selection 1055 generates the input (e.g., remediated data or configuration for models) to the AutoAI model generation processing 750 (FIGS. 7-9) and generates the AutoAI generated models processing 760.

FIG. 10C shows the example interface of FIG. 10A showing a data source inspector/preview interface 1065 used for automatic assessment of data quality of data input into an ML model and data remediation, according to one embodiment. In one embodiment, the preview data icon (or button, selection, etc.) 1060 opens the inspector/preview interface 1065. The inspector/preview interface 1065 opens the data source in a user-friendly format. In this example, the data in row 2 shows data 1070 for residence_since as 3.0 (3 years). In this example, the user desires to remediate the data 1070 in row 2 for residence_since from 3.0 (3 years) to 2.0 (2 years). In one embodiment, selection of the data 1070 (e.g., 3.0) provides the user the ability to modify the data 3.0 to 2.0, which is confirmed by selecting the confirm button or selection 1075.

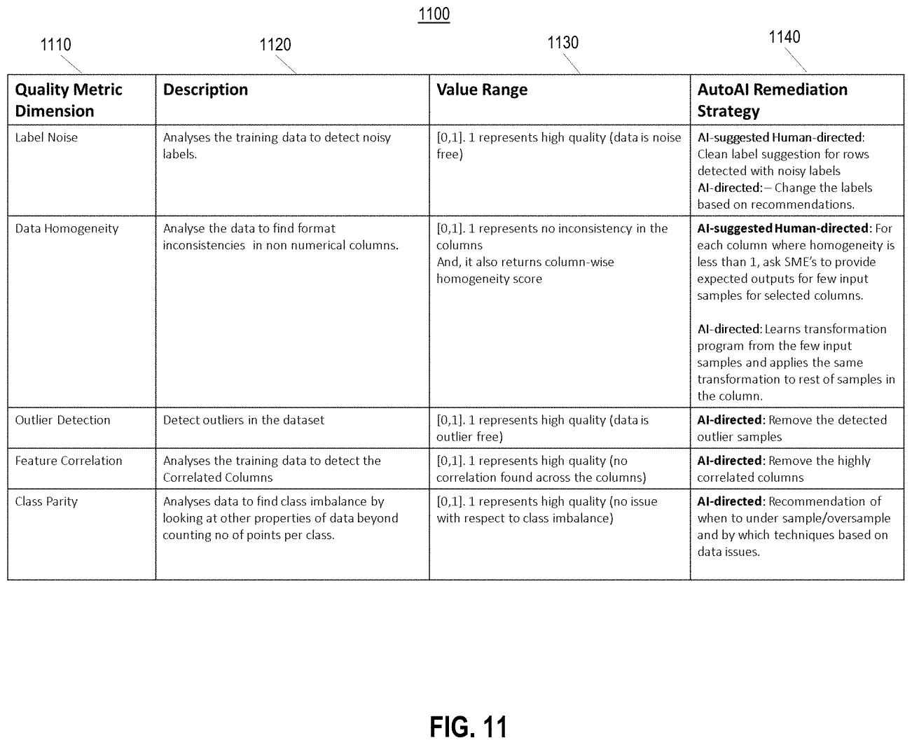

FIG. 11 shows a table 1100 of data quality metrics and remediation strategies, according to one embodiment. In one embodiment, the table 1100 includes a quality metric dimension column 1110, a description column 1120, a value range column 1130 and AutoAI remediation strategy column 1140. The quality metric dimension column 1110 provides the data quality metric selections, which may have the AutoAI remediation strategy for option 1 730 (FIG. 7) or option 2 740, depending on the selection of the quality metric dimension. For example, for a label noise selection in the quality metric dimension column 1110, the AutoAI remediation strategy column 1140 provides either option 1 730 (e.g., AI-suggested Human directed: clean label suggestion for rows detected with noisy labels or option 2 740 AI-directed-change the labels based on recommendations).

FIG. 12 illustrates a block diagram of a process 1200 for automatic assessment of data quality of data input into an ML model and data remediation, according to one embodiment. In one embodiment, in block 1210, process 1200 receives, by a computing device (from computing node 10, FIG. 1, hardware and software layer 60, FIG. 2, processing system 300, FIG. 3, system 400, FIG. 4, system 500, FIG. 5, etc.), input (e.g., input 710, FIGS. 7-9) data for an automated machine learning model. In block 1220, process 1200 further displays (e.g., via an interface 1000, FIGS. 10A-C), by the computing device, selections for multiple data quality metrics. In block 1230, process 1200 further receives, by the computing device, a selection for one or more data quality metrics from the multiple data quality metrics. In block 1240, process 1200 additionally determines, by the computing device, the one or more data quality metrics according to the selection of the one or more data quality metrics. In block 1250, process 1200 additionally displays, by the computing device, selections for one or more data remediation strategies based on the selection of the one or more data quality metrics. In block 1260, process 1200 still further receives a selection for one or more remediation recommendation strategies. In block 1270, process 1200 additionally performs, by the computing device, the selected one or more data remediation strategies on the input data. In block 1280, process 1200 further learns, by the computing device, from the selection of the one or more data quality metrics and the selection for the one or more data remediation strategies. In block 1290, process 1200 still further generates, by the computing device, a new customized machine learning model based on the learning.

In one embodiment, process 1200 may additionally include the feature that the selections for the data quality metrics include label noise, data homogeneity, data outlier detection, feature correlation and class parity.

In one embodiment, process 1200 may additionally include the feature that the selections for the data remediation strategies include remediations to the input data or a system directed configuration for learning models.

In one embodiment, process 1200 may still additionally include the feature that the remediation strategies involving remediations to the input data comprise one or more data modification suggestions.

In one embodiment, process 1200 may still further include the feature that the remediation strategies involving the system directed configuration for learning models comprise one or more directives for AutoAI model generation for generating the new customized machine learning model.

In one embodiment, process 1200 may include the feature that selections for the data quality metrics and the selections for the data remediation strategies are displayed with a graphical user interface.

In one embodiment, process 1200 may include the feature of modifying the input data by a table embedding model that generates remediation recommendations in tabular format for the input data.

These and other features, aspects and advantages of the present embodiments will become understood with reference to the following description, appended claims and accompanying figures.

One or more embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to automatically assess data quality of data input into a machine learning model and remediate the data, the method comprising:
receiving, by a computing device, input data for an automated machine learning model;
displaying, by the computing device, selections for a plurality of data quality metrics;
receiving, by the computing device, a selection for one or more data quality metrics from the plurality of data quality metrics;
determining, by the computing device, the one or more data quality metrics according to the selection of the one or more data quality metrics;
displaying, by the computing device, selections for one or more data remediation strategies based on the selection of the one or more data quality metrics;
receiving, by the computing device, a selection for one or more remediation recommendation strategies;
performing, by the computing device, the selected one or more data remediation strategies on the input data;
learning, by the computing device, from the selection of the one or more data quality metrics and the selection for the one or more data remediation strategies; and
generating, by the computing device, a new customized machine learning model based on the learning.

2. The method of claim 1, wherein the selections for the plurality of data quality metrics comprise label noise, data homogeneity, data outlier detection, feature correlation and class parity.

3. The method of claim 1, wherein the selections for the one or more data remediation strategies comprise remediations to the input data or a system directed configuration for learning models.

4. The method of claim 3, wherein the one or more remediation strategies involving remediations to the input data comprise one or more data modification suggestions.

5. The method of claim 3, wherein the one or more remediation strategies involving the system directed configuration for learning models comprise one or more directives for Automatic artificial intelligence (AutoAI) model generation for generating the new customized machine learning model.

6. The method of claim 1, wherein selections for the plurality of data quality metrics and the selections for the one or more data remediation strategies are displayed with a graphical user interface.

7. The method of claim 6, further comprising:
modifying, by the computing device, the input data by a table embedding model that generates remediation recommendations in tabular format for the input data.

8. A computer program product for automatically assessment of data quality of data input into a machine learning model and remediation of the data, the computer program product comprising a computer readable storage medium having program instructions embodied therewith, the program instructions executable by a processor to cause the processor to:
receive, by the processor, input data for an automated machine learning model;
display, by the processor, selections for a plurality of data quality metrics;
receive, by the processor, a selection for one or more data quality metrics from the plurality of data quality metrics;
determine, by the processor, the one or more data quality metrics according to the selection of the one or more data quality metrics;
display, by the processor, selections for one or more data remediation strategies based on the selection of the one or more data quality metrics;
receive, by the processor, a selection for one or more remediation recommendation strategies;
perform, by the processor, the selected one or more data remediation strategies on the input data;
learn, by the processor, from the selection of the one or more data quality metrics and the selection for the one or more data remediation strategies; and
generate, by the processor, a new customized machine learning model based on the learning.

9. The computer program product of claim 8, wherein the selections for the plurality of data quality metrics comprise label noise, data homogeneity, data outlier detection, feature correlation and class parity.

10. The computer program product of claim 8, wherein the selections for the one or more data remediation strategies comprise remediations to the input data or a system directed configuration for learning models.

11. The computer program product of claim 10, wherein the one or more remediation strategies involving remediations to the input data comprise one or more data modification suggestions.

12. The computer program product of claim 10, wherein the one or more remediation strategies involving the system directed configuration for learning models comprise one or more directives for Automatic artificial intelligence (AutoAI) model generation for generating the new customized machine learning model.

13. The computer program product of claim 8, wherein selections for the plurality of data quality metrics and the selections for the one or more data remediation strategies are displayed with a graphical user interface.

14. The computer program product of claim 13, wherein the program instructions executable by the processor further cause the processor to:
modify, by the processor, the input data by a table embedding model that generates remediation recommendations in tabular format for the input data.

15. An apparatus comprising:
a memory configured to store instructions; and
a processor configured to execute the instructions to:
receive input data for an automated machine learning model;
display selections for a plurality of data quality metrics;
receive a selection for one or more data quality metrics from the plurality of data quality metrics;
determine the one or more data quality metrics according to the selection of the one or more data quality metrics;
display selections for one or more data remediation strategies based on the selection of the one or more data quality metrics;
receive a selection for one or more remediation recommendation strategies;
perform the selected one or more data remediation strategies on the input data;
learn from the selection of the one or more data quality metrics and the selection for the one or more data remediation strategies; and
generate a new customized machine learning model based on the learning.

16. The apparatus of claim 15, wherein:
the selections for the plurality of data quality metrics comprise label noise, data homogeneity, data outlier detection, feature correlation and class parity; and
the selections for the one or more data remediation strategies comprise remediations to the input data or a system directed configuration for learning models.

17. The apparatus of claim 16, wherein the one or more remediation strategies involving remediations to the input data comprise one or more data modification suggestions.

18. The apparatus of claim 16, wherein the one or more remediation strategies involving the system directed configuration for learning models comprise one or more directives for Automatic artificial intelligence (AutoAI) model generation for generating the new customized machine learning model.

19. The apparatus of claim 15, wherein selections for the plurality of data quality metrics and the selections for the one or more data remediation strategies are displayed with a graphical user interface.

20. The apparatus of claim 19, wherein the processor is further configured to execute the instructions to:
modify the input data by a table embedding model that generates remediation recommendations in tabular format for the input data.
